(19) United States
(12) Patent Application Publication
(10) Pub. No.: US 2005/0080193 A1
(43) Pub. Date: Apr. 14, 2005

(54) Sound dampening adhesive

(76) Inventors: Dominique Wouters, Gierle (BE); Jos Vorsselmans, Hoogstraten (BE); Zhisong Huang, San Dimas, CA (US)

Correspondence Address: Heidi A. Boehlefeld;Renner, Otto, Boisselle & Sklar, LLP, Nineteenth Floor, 1621 Euclid Avenue, Cleveland, OH, 44115, US

(21) Appl. No.: 10/961,873

(22) Filed: Oct. 8, 2004

Related U.S. Application Data
(60) Provisional application No. 60/509,796, filed on Oct. 8, 2003.

(51) Int. Cl. C08F 8/00

(52) U.S. Cl. 525/191

(57) ABSTRACT

Pressure sensitive adhesive compositions that exhibit sound/vibration dampening properties are provided. The pressure sensitive adhesive composition can be tailored to provide sound/vibration dampening within a desired temperature range at a specified frequency.

This application claims priority to provisional application Ser. No. 60/509,796 filed on Oct. 8, 2003, the content of which is hereby incorporated by reference in its entirety.

### FIELD OF THE INVENTION

The present invention is directed to modified acrylic based pressure sensitive adhesive compositions that exhibit sound/vibration dampening properties at elevated temperatures. The pressure sensitive adhesive composition can be tailored to provide sound/vibration dampening within a desired temperature range at a specified frequency.

### BACKGROUND OF THE INVENTION

Sound and vibration dampening adhesives are known for use in the automotive, electronics and appliance industries. As pressure sensitive adhesives are visco-elastic materials, they exhibit sound and vibration dampening properties. Sound dampening acrylate pressure sensitive adhesives generally are formulated to provide optimal sound dampening at room temperature or near room temperature. Because the temperature at which these adhesive are used can rise above room temperature, there is a need for a pressure sensitive adhesive with optimal dampening properties at higher temperatures.

### SUMMARY OF THE INVENTION

The present invention relates to a vibration dampening adhesive comprising a blend of an acrylic pressure sensitive adhesive and a modifying resin having a high glass transition temperature (Tg). The adhesive of the present invention provides sound and vibration dampening at elevated temperatures, e.g., temperatures higher than room temperature, and at high frequencies, typically about 100 Hz to about 10 kHz. The dampening adhesive formulation may be tailored to the application requirements. The adhesive is a pressure sensitive adhesive that can be laminated onto substrates at room temperature, without the need for special equipment or process, such as radiation curing or in-situ curing at high temperatures.

In one embodiment, the invention is directed to a vibration dampening pressure sensitive adhesive comprising a blend of about 40% to about 95% by weight of an acrylic based adhesive; and 5% to about 60% by weight of a thermoplastic modifying polymer having a Tg of at least 50° C.; the pressure sensitive adhesive has a material loss factor equal to or greater than about 0.8 at at least one frequency in the range of about 100 Hz to about 10 kHz and within a temperature span of at least 35° C. within the temperature region above 35° C.

In one embodiment, the invention is directed to a pressure sensitive adhesive useful for damping purposes comprising a blend of: (a) 40-95% by weight of a copolymer comprising on a copolymerized basis from about 55% to about 85% by weight of a monomer selected from the group consisting of alkyl acrylate esters and alkyl methacrylate esters containing from 4 to about 12 carbon atoms in the alkyl group and mixtures thereof, from 0 to about 35% by weight of an alkyl acrylate or methacrylate ester containing less than 4 carbon atoms in the alkyl group, from 0 to about 2% by weight of a glycidyl monomer, from about 0 to about 10% by weight of an N-vinyl lactam, and from 0 to about 15% by weight of an unsaturated carboxylic acid; and (b) 5-60% by weight of a thermoplastic modifying polymer having a Tg of at least 50° C.

In one embodiment, the invention is directed to a damping adhesive construction comprising: (a) a damping adhesive comprising a blend of: 40-95% by weight of an acrylic adhesive; and 5-60% by weight of a thermoplastic modifying polymer having a Tg of at least 50° C.; the pressure sensitive adhesive has a material loss factor equal to or greater than about 0.8 at at least one frequency in the range of about 100 Hz to about 10 kHz and within a temperature span of at least 35° C. within the temperature region above 35° C.; and (b) at least one substrate, wherein the adhesive is adhered to or laminated to the substrate. The substrate may be polymeric, paper or metal, with or without an overlying coating, or composites thereof, with the adhesive adhered to or laminated on one or both sides of the substrate.

### BRIEF DESCRIPTION OF THE DRAWINGS

FIGS. 1A and 1B are nomograms illustrating the vibration dampening properties of the comparative adhesives of Example 1A and 1B, respectively.

FIGS. 2-4 are nomograms illustrating the vibration dampening properties of an adhesive in accordance with the present invention, namely Examples 2-4, respectively.

FIG. 5 is a graph of the composite loss factor vs. temperature for the adhesive of Example 5.

FIGS. 6-8 are nomograms illustrating the vibration dampening properties of an adhesive in accordance with the present invention, namely Examples 6-8, respectively.

### DETAILED DESCRIPTION OF THE INVENTION

Pressure sensitive adhesives of the instant invention are prepared by modifying an acrylic based pressure sensitive adhesive with a high Tg modifying resin. As used herein, the term “high Tg” means a Tg of at least 50° C.

The acrylic based adhesive may comprise a copolymer of monomers, including one or more first monomers including alkyl acrylates such as butyl acrylate, propyl acrylate, 2-ethyl hexylacrylate, isooctyl acrylate, isodecylacrylate, and the like. The balance of the monomer system may be comprised of second monomers including ethyl acrylate, alkyl methylacrylate such as methyl methacrylate, ethyl methacrylate, butyl methacrylate and the like; copolymerizable vinyl-unsaturated monomers such as vinyl acetate, vinyl propionate and the like, styrenic monomers such as styrene, methyl styrene and the like, unsaturated carboxylic acids such as acrylic acid, methacrylic acid, itaconic acid, fumaric acid, and the like; acrylamide, vinyl caprolactam and the like.

The acrylic copolymer may be crosslinked by exposure to heat, ionic additive, actinic radiation or electron beam radiation, or using UV active functionality in the polymer or additives.

Useful acrylic pressure sensitive adhesives for the damping adhesive of the present invention are described in U.S. Pat. No. 4,812,541, the entire disclosure of which is hereby incorporated by reference. These high performance pressure sensitive adhesives provide unusually high adhesion to high energy surfaces such as aluminum and stainless steel due to the synergistic combination of a glycidal monomer and an N-vinyl lactam.

Useful acrylic pressure sensitive adhesives include Polytex 7000, Polytex 7000HS and Polytex 7600, produced by Avery Chemical, Division of Avery Dennison Corporation. These are solvent based acrylate copolymer adhesives.

In one embodiment, the acrylic based pressure sensitive adhesive comprises an acrylic copolymer that contains a glycidyl monomer and an N-vinyl lactam monomer. The acrylic copolymer of the pressure sensitive adhesive may contain on a copolymerized basis from about 0.01 to about 2% by weight glycidyl monomer, about 1% to about 10% by weight of a N-vinyl lactam monomer, from 0 to about 15% by weight of an ethylenically unsaturated carboxylic acid, from about 55 to about 85% by weight an alkyl acrylate or methacrylate ester containing from 4 to about 12 carbon atoms in the alkyl group, from 0 to about 35% by weight of an alkyl acrylate or methacrylate ester containing less than 4 carbon atoms in the alkyl group. The Tg of the acrylic copolymer is lower than about −15° C.

In another embodiment, the acrylic copolymer of the pressure sensitive adhesive comprises at least 55% by weight of an alkyl acrylate or methacrylate ester containing from 4 to about 12 carbon atoms in the alkyl group, and does not contain a glycidyl monomer. In yet another embodiment, the acrylic copolymer does not contain an N-vinyl lactam monomer.

The alkyl acrylate and methacrylate esters containing 4 to about 12 carbon atoms in the alkyl group useful in forming the polymers of the instant invention include without limitation 2-ethyl hexyl acrylate, isooctyl acrylate, butyl acrylate, sec-butyl acrylate, methyl butyl acrylate, 4-methyl-2-pentyl acrylate, isodecyl methacrylate and the like and mixtures thereof.

The glycidyl monomers are glycidyl acrylate, glycidyl methacrylate, allyl glycidyl ether and mixtures thereof.

The N-vinyl lactams monomers which may be used include N-vinyl pyrrolidone, N-vinyl caprolactam, 1-vinyl-2-piperidone, 1-vinyl-5-methyl-2-pyrrolidone, and the like.

Ethylenically unsaturated carboxylic acids include acrylic acid, methacrylic acid, fumaric acid, and the like.

Alkyl acrylate and methacrylate esters containing less than 4 carbon atoms in the alkyl group include methyl acrylate, ethyl acrylate, methyl methacrylate and the like.

Other monomers which can be included are polystyryl ethyl methacrylate, acetoacetoxy ethyl methacrylate, alpha olefins such as ethylene and propylene and vinyl esters of alkanoic acids containing more than three carbon atoms as well as mixtures thereof. Such monomer concentrations are in the range from 0 to about 35 percent by weight of the total monomers.

The acrylic based pressure sensitive adhesive may also comprise an emulsion acrylic PSA polymer. The acrylic PSA polymer can be inherently tacky or compounded with an external tackifier, such as a hydrocarbon resin, a rosin or rosin derivative, or other tackifier commonly used in the manufacture of PSAs. Acrylic PSA copolymers are prepared using standard polymerization techniques, for example, free radical polymerization. Emulsion polymerization is a particularly useful technique, but the reaction can also be performed as a solvent polymerization, a bulk or hot melt polymerization, a radiation-induced polymerization, etc. In one embodiment, an acrylic emulsion PSA is prepared by allowing the monomers to react in the presence of suitable polymerization initiators and emulsifiers (surfactants). In some embodiments, one or more activators and chain transfer agents (or other molecular weight regulators) are also employed in the reaction.

Enough initiator is used to promote free-radical polymerization of the monomers. A small amount of base, e.g., ammonium hydroxide, sodium hydroxide, sodium bicarbonate, etc., can be added to the initiator to stabilize the emulsion polymerization.

Non-limiting examples of emulsifiers include both anionic and nonionic surfactants and stabilizers, including without limitation, alkyl phenol ethoxylates, such as nonylphenol ethoxylate (a nonionic surfactant sold as POLYSTEP F9 by Stepan Company Inc. of Winnetka, Ill.), alkylaryl sulfonates, such as sodium dodecylbenzene sulfonate (an anionic surfactant sold as Rhodacal DS10 by Rhodia, of Cranbury, N.J.), and Rhodacal A246L (an alpha olefin sulfonate available from Rhodia), Disponil FES77, a sodium lauryl ether sulfate surfactant, available from Henkel of America, Inc. (King of Prussia, Pa.); TSPP (sodium pyrophosphate), available from J. T. Baker (Mallinckrodt Baker, Inc., Phillipsburg, N.J.); and Aerosol OT-75, a sodium dioctyl sulfosuccinate surfactant, available from American Cyanamid (Wayne, N.J.). Other nonlimiting examples of useful surfactants include cetyl trimethyl ammonium bromide, available from Aldrich (Milwaukee, Wis.); AR-150, a nonionic, ethoxylated rosin acid emulsifier available from Hercules, Inc. (Wilmington, Del.); Alipal CO-436, a sulfated nonylphenol ethoxylate available from Rhodia; Trem LF40, a sodium alkyl allyl sulfosuccinate surfactant, available from Henkel of America, Inc.; Polystep B-27, a sodium nonylphenol ethoxylated sulfate, available from Stepan Company, Inc. (Winnetka, Ill.); and disodium ethoxylated alkyl alcohol half esters of sulfosuccinic acid, described in U.S. Pat. No. 5,221,706 (incorporated by reference herein), and available from VWR Scientific Corp., Sargent-Welch Division (Westchester, Pa.). Other surfactants include the Triton X-series of surfactants made by Union Carbide (Danbury, Conn.). In general, a cationic and an anionic surfactant would not be employed in the same polymerization reaction. Anionic plus nonionic surfactant combinations, however, are readily used to prepare the emulsion copolymers described herein. The emulsifiers are employed in an amount sufficient to form stable monomer emulsions.

While actual production techniques may vary depending upon particular monomer compositions, available equipment, and other considerations, in general, the emulsion polymers are prepared by first mixing one or more pre-emulsions containing conventional surfactants, sodium bicarbonate, and some or all of the monomers in deionized water; adding reactive surfactants (if any) and other reactor ingredients (e.g., Fe-EDTA, AR 150, hydrogen peroxide) to a nitrogen-purged reactor; heating the reactor to 70° C.+/−2° C. and then adding a pre-emulsion charge over time (preferably in stepped or mixed feed sequences); adding an initiator charge containing, for example, potassium persulfate; continuing the pre-emulsion feeds and addition of any accelerators; adding any post-reaction charges (e.g., t-BHP, ascorbic acid, and more water); cooling the reactor contents to below 35° C.; and filtering the emulsion polymer. Before filtering the reaction mixture, a biocide, for example, Kathon LX (available as a 1.5% solution from Rohm & Haas, Philadelphia, Pa.), can be added to prevent bacterial growth.

In some embodiments, the copolymers are prepared by sequential polymerization and the monomers are allowed to react in distinct stages. Methods for the sequential polymerization of emulsion acrylic PSAs are disclosed, for example, in U.S. Pat. Nos. 5,895,801 and 6,147,165, the disclosures of which are incorporated herein by reference.

In one embodiment, the acrylic based pressure sensitive adhesive comprises an acrylic saturated rubber hybrid PSA. Such hybrid PSAs are formed by polymerizing an alkyl ester monomer system in the presence of a macromer of ethylene-butylene or ethylene-propylene containing a reactive acrylate or methacrylate end group. The product is a comb type graft copolymer having acrylic backbone and pendant side chains of low glass transition temperature ethylene-butylene and/or ethylene-propylene macromer. The graft polymerization can be carried out using solution, suspension or emulsion polymerization techniques. Such hybrid PSAs are described in U.S. Pat. No. 5,625,005, the disclosure of which is incorporated herein by reference.

A high Tg modifying resin is blended with the acrylic copolymer to optimize sound/vibration damping at higher temperatures. The amount of modifying resin blended with the acrylic copolymer depends on the desired temperature and frequency range where dampening performance is to be optimized. In one embodiment, the amount of high Tg modifying resin blended with the acrylic copolymer is within the range of about 5 to 60%, based on the total solids. In another embodiment, the amount of high Tg modifying resin blended with the acrylic copolymer is within the range of about 10 to 40%, or 20 to 30% based on the total solids.

The glass transition temperature and chemical composition of the modifying resin used depends on the target frequency and temperature range for which optimal sound and/or vibration dampening is desired. In addition, the high Tg modifying resin should be blendable with the acrylic based pressure sensitive polymer. Examples of useful modifying resins include acrylic resins, copolyester resins, polyurethanes, terpenes, terpene phenolics and derivatives thereof, including hydrogenated and aromatic modified terpenes, rosin including hydrogenated and esterified rosin, polyphenylene ethers, polyketones, coumarone-indene resins, and blends of high Tg resins. In one embodiment, the modifying resin comprises a terpene phenolic resin.

Useful commercially available high Tg acrylic resins include Viacryl SC 108/50T (Tg=57.6° C.) from Solutia, Paraloid B-99 (Tg=82° C.) and Paraloid A-21 (Tg=105° C.) from Rohm and Haas.

Useful commercially available high Tg copolyester resins include the series VITEL brand from Bostik (USA) and the series DYNAPOL brand from Huls AG (Germany). A particularly useful copolyester resin is DYNAPOL S1611 (Tg-50° C.). Other high Tg resins include Reagem 5110, a hydroxylated terpene phenolic resin (Tg=57.3° C.), Dertophene 1510, a terpene phenolic resin (Tg=102.3° C.), both from DRT of France; K-1626, a rosin-ester based resin (Tg=122° C.) from Resolution Specialty Materials of Belgium; and PPO SA 120, a polyphenylene ether (Tg=152° C.) from General Electric Advanced Materials.

Blending of the acrylic copolymer and the modifying resin is done by any method that results in a substantially homogeneous distribution of the acrylic copolymer and modifying resin in the coated adhesive. The blend can be prepared by solvent blending, hot melt blending, emulsifying, etc. In the case of solvent blending, the copolymers should be substantially soluble in the solvents used.

Any suitable solvent may be used to form the adhesive coating solution. Typical solvents include tetrahydrofuran, toluene, xylene, hexane, heptane, cyclohexane, cyclohexanone, methylene chloride, isopropanol, ethanol, ethyl acetate, butyl acetate, isopropyl acetate and the like.

Additives, such as pigments, fillers, ultraviolet light absorbers, ultraviolet stabilizers, antioxidants, plasticizers, tackifiers, fire retardant agents, thermally or electrically conductive agents, post curing agents, and the like may be blended into the adhesive composition to modify the properties of the adhesive. Ultraviolet light absorbers include hydroxyphenyl benzotriazoles and hydrobenzophenones. UV stabilizers are commonly hindered amine light stabilizers. Antioxidants include, for example, hindered phenols, amines, and sulfur and phosphorus hydroxide decomposers, such as Irganox 1520L. Typically, such additives are used in amounts of about 0.1 to about 30 parts per hundred parts of total solids.

Various release layers are available that may be applied to the adhesive and are useful in protecting the pressure sensitive adhesive from inadvertently bonding prior to use. Suitable release layers are described in some detail in Chapter 23 of the Handbook of Pressure Sensitive Adhesive Technology, 2d Ed., edited by Donatas Satas, and incorporated herein by reference. If an adhesive layer is applied to both sides of a substrate, or a transfer tape is desired, then release layers can be applied to both adhesive layers or sides. These two release layers can be differentially releasable from the adhesive layers to provide additional convenience in application. In one embodiment, the adhesive is coated onto a double sided siliconized liner to produce a transfer tape or a double coated tape.

The material loss factor is an indication of the vibration (and sound) damping properties of a material. The composite loss factor is a measure of the conversion of vibrational energy to thermal energy. A conventional high damping material composition is generally required to have a material loss factor of not less than 0.8. In a constraint layer construction, the total composite loss factor, including the constraint layer substrates and the visco-elastic damping material, is generally required to be not less than 0.1.

The pressure sensitive adhesive of the present invention generally has a material loss factor equal to or greater than about 0.8 at at least one frequency in the range of about 100 Hz to about 10 kHz and within a temperature span of at least 35° C. within the temperature region above 35° C. In one embodiment, the pressure sensitive adhesive has a material loss factor equal to or greater than about 0.8 at at least one frequency in the range of about 100 Hz to about 10 kHz and within a temperature span of at least 35° C. within the temperature region above 40° C. In another embodiment, the pressure sensitive adhesive has a material loss factor equal to or greater than about 0.8 at at least one frequency in the range of about 100 Hz to about 10 kHz and within a temperature span of at least 35° C. within the temperature region above 70° C.

The damping pressure sensitive adhesive can be used in various adhesive constructions. For example, the adhesive can be applied to a substrate or carrier film. The carrier film may be a polymeric film, such as a polyester, polyethylene, polypropylene, polyurethane, or polyvinyl chloride film or multilayer film or blend of one or more of these. The substrate or carrier film can also be a release liner, or paper substrate. Substrates or carriers include, but are not limited to film form, felt, woven, knitted, non-woven, scrim, foamed, or cavitated. Other substrates include, but are not limited to, metal such as aluminum, steel, and stainless steel, with or without a coating overlying the metal. The adhesive construction may be a transfer tape, single coated or double coated construction with one or two liners.

Test Methods

The glass transition temperature, Tg, is measured using the DSC method on a TA Instruments DSC Model 2920 at 5° C./min temperature increase rate with the samples sealed in an aluminum pan.

The loss factor data and nomograms are generated from a vibrating beam tester (VBT) available from Damping Technologies Inc., U.S., in accordance with ASTM-E-756-98. Composite loss factors are obtained from the measurement in a sandwich construction, using beams with known material properties. The material loss factor is calculated from this composite loss factor, taking into account the mechanical properties of the sandwich materials used.

Peel adhesion properties are determined using a method based on Finat FTM 1 method, with a speed of 300 mm/min and strip width of 25 mm. When testing transfer tapes, the tapes are reinforced with a 36 μm polyester strip. The dwell time before measurement is 24 hours. The test substrates used are standard stainless steel and smooth thick polyethylene film.

Dynamic shear properties are determined using a method based on Finat FTM 18 method. The test area is 25×25 mm² and the test speed is 2 mm/min. the substrates used are a stainless steel panel on one side, and a stainless steel foil on the other side. The dwell time is 24 hours.

### EXAMPLES

The following examples are intended to illustrate the present invention and not to limit it. All percentages are by dry weight in the final adhesive, unless otherwise specified.

### Comparative Example 1A

As a comparative example, a pure acrylic adhesive is coated on a commercial solvent coating line. The composition of the adhesive, on a dry weight basis is as follows:

| Ingredient | Weight (%) |
|---|---|
| Polytex 7000HS¹ | 99.97 |
| Aluminum² | 0.03 |

¹Acrylic PSA produced by Avery Dennison Performance Polymers, Division of Avery Dennison Corporation.
²Aluminum crosslinker provided in the form of aluminum acetyl acetonate

The ingredients are mixed in toluene and diluted with toluene to provide a suitable coating for a roller coating station. After removal of the solvent, the residual solvent is less than 3% by weight.

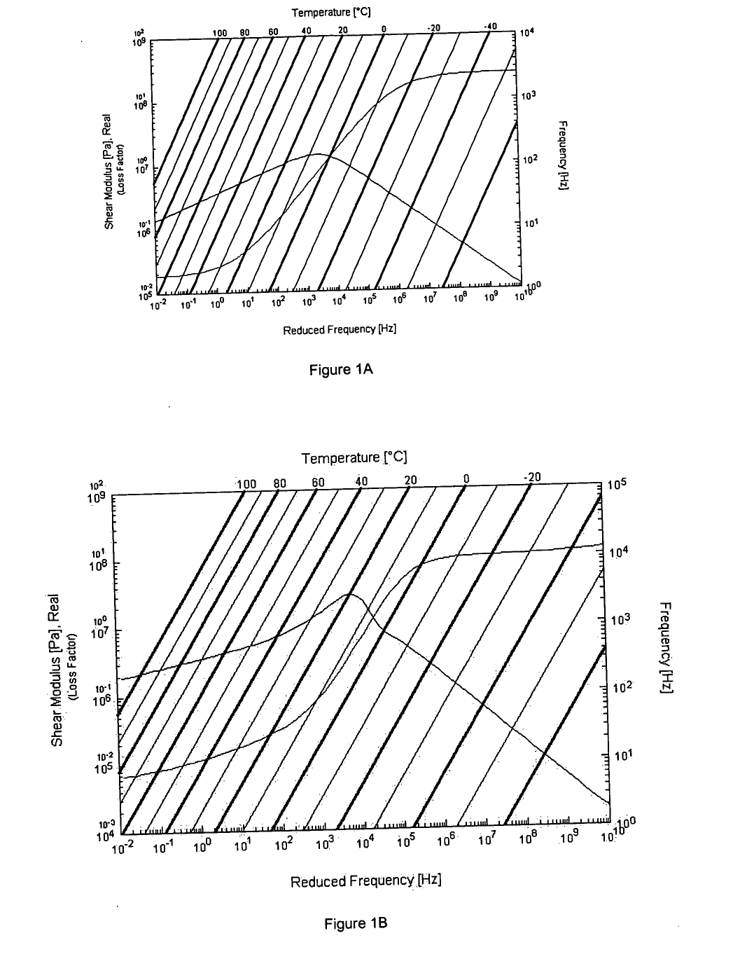

The physical properties of the adhesive are shown in Table 1 below. The adhesive has good adhesion to stainless steel and good dynamic shear. The adhesion to polyethylene is limited, which is typical for a pure acrylic adhesive. A nomogram of the material loss factor, as measured with the Vibrating Beam Technique in accordance with ASTM-E-756-98 is given in FIG. 1. Table 2 lists the loss factor measured at the frequencies of 100 Hz, 1 kHz and 10 kHz. For the adhesive of Comparative Example 1A, the loss factor drops significantly at higher temperatures, resulting in insufficient damping.

### Comparative Example 1B

A modified acrylic adhesive is prepared of the following ingredients:

| Ingredient | Weight (%) |
|---|---|
| I-970¹ | 100 |

¹Modified acrylic PSA formulated at Avery Dennison Specialty Tape Division (US) of Avery Dennison Corporation.

The I-970 adhesive contains 33.2% by weight of a rosin based resin having a Tg of 39° C. A nomogram of the material loss factor, as measured with the Vibrating Beam Technique in accordance with ASTM-E-756-98 is given in FIG. 1. Table 2 lists the loss factor measured at the frequencies of 100 Hz, 1 kHz and 10 kHz. The adhesive of Comparative Example 1B does not possess good damping properties in the 100 Hz to 10 kHz region at temperatures higher than room temperature.

### Example 2

A sound dampening adhesive is prepared of the following ingredients:

| Ingredient | Weight (%) |
|---|---|
| AVC 5580¹ | 74.91 |
| Reagem 5110² | 24.94 |
| Isocyanate curing | 0.14 |
| agent | |
| dibutyltin dilaurate | 0.01 |

¹Acrylic PSA produced by Avery Dennison Performance Polymers, Division of Avery Dennison Corporation.
²Hydroxylated terpene phenolic polyester resin from DRT (France), Tg = 57.3° C.

AVC 5580 is a solution acrylic adhesive having a Tg of −44° C. formed from the monomers 2-ethyl hexyl acrylate, butyl acrylate, vinyl acetate, and acrylic acid. Before coating, the ingredients are mixed in toluene and diluted with toluene to about 30% dry mass to provide a coatable adhesive on the tape substrate. The tape is dried at 110° C. for 10 to 15 minutes. The residual solvent is typically <2% by weight.

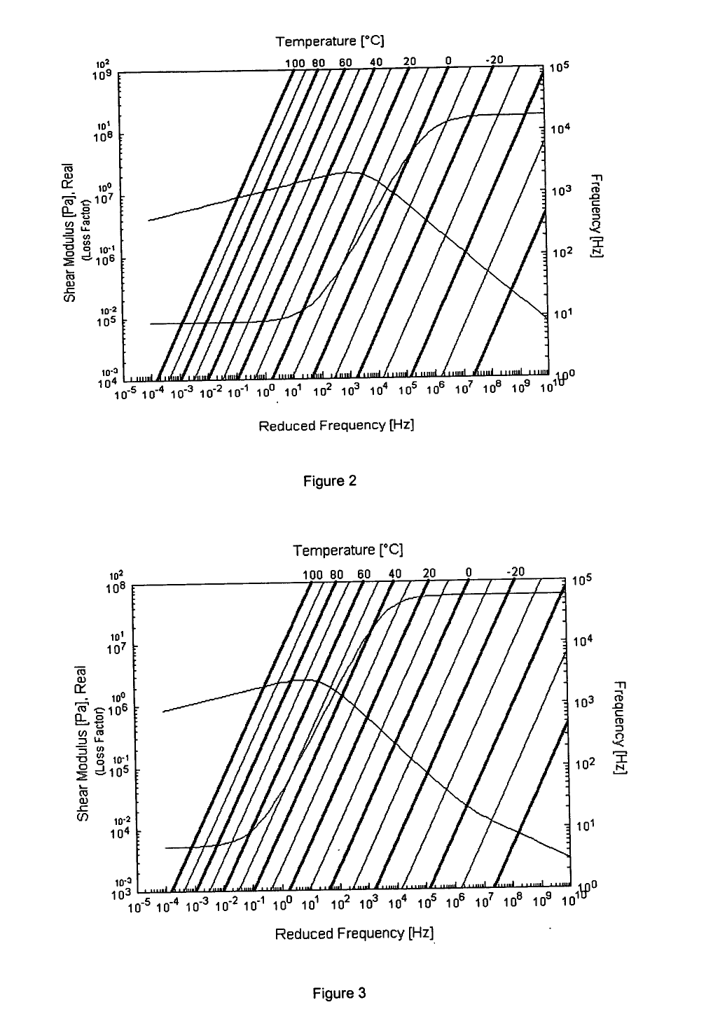

A nomogram of the material loss factor is shown in FIG. 2. The adhesive exhibits improved damping at higher temperatures.

### Example 3

A sound dampening adhesive is prepared of the following ingredients:

| Ingredient | Weight % |
|---|---|
| Polytex 7000HS¹ | 74.63 |
| Dertophene 1510² | 25.35 |
| Aluminum³ | 0.02 |

¹Acrylic PSA produced by Avery Dennison Performance Polymers, Division of Avery Dennison Corp., Tg = −50.9° C.
²Terpene phenolic resin from DRT (France), Tg = 102.3° C.
³Added as Aluminum acetyl acetonate crosslinker

The ingredients are mixed and diluted with toluene to a dry mass content of about 30%. The adhesive sample is coated on a lab coater and dried for 10 to 15 minutes at 110° C. The residual solvent is less than 1%.

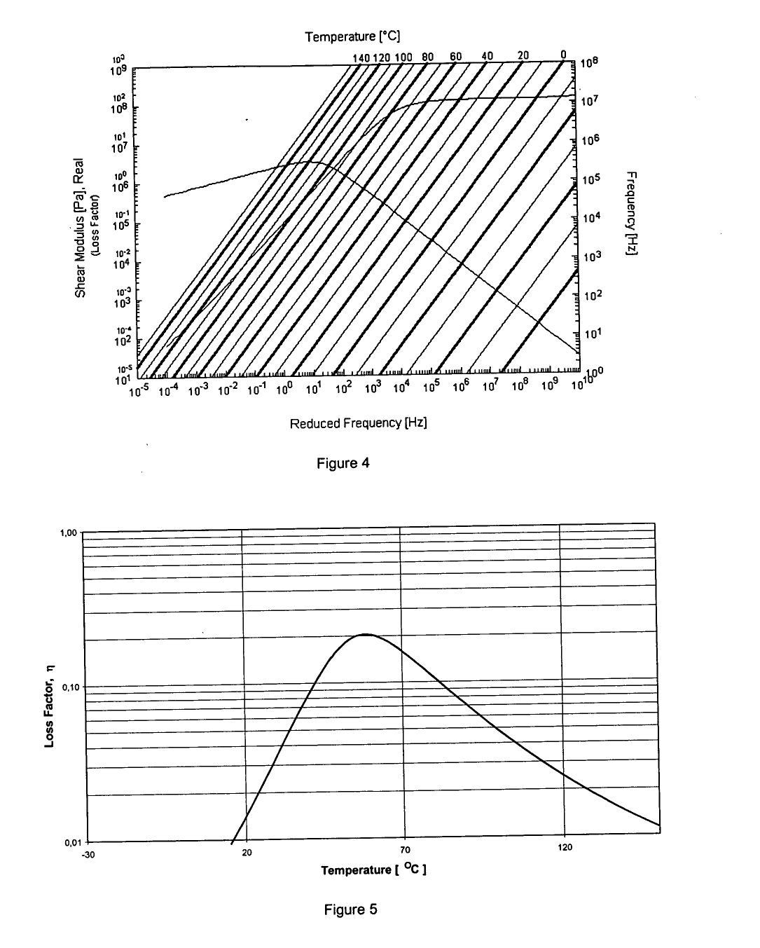

A nomogram of the material loss factor for the adhesive of Example 3 is shown in FIG. 3.

### Example 4

A sound dampening adhesive is prepared substantially is accordance with the procedure of Example 3 with the following ingredients:

| Ingredient | Weight (%) |
|---|---|
| Aroset 516¹ | 70.6 |
| Dertophene 1510² | 29.4 |

¹Acrylic PSA produced by Ashland Chemicals, Tg = −51.2° C.
²Terpene phenolic resin from DRT (France), Tg = 102.3° C.

A nomogram of the material loss factor for the adhesive of Example 4 is shown in FIG. 4. The adhesive exhibits good damping performance at 100 Hz, 1 kHz and 10 kHz frequencies as shown in Table 2.

### Example 5

A sound dampening adhesive is prepared substantially in accordance with the procedure of Example 3 with the following ingredients:

| Ingredient | Weight (%) |
|---|---|
| Polytex 7000HS¹ | 69.87 |
| K-1626² | 30.11 |
| Aluminum³ | 0.02 |

¹Acrylic PSA produced by Avery Dennison Performance Polymers, Division of Avery Dennison Corp., Tg = −50.9° C.
²Rosin-ester based resin from Resolution Specialty Materials (Belgium), Tg = 122° C.
³Added as Aluminum acetyl acetonate crosslinker

A graph of the composite loss factor of the adhesive of Example 5, measured at 2 kHz, is shown in FIG. 5.

### Example 6

A sound dampening adhesive is prepared in accordance with the procedure of Example 3 with the following ingredients:

| Ingredient | Weight (%) |
|---|---|
| Durotak 480-1760¹ | 70.4 |
| Dertophene 1510² | 29.6 |

¹Acrylic PSA from National Starch & Chemical, Tg = −37.8° C.
²Terpene phenolic resin from DRT (France), Tg = 102.3° C.

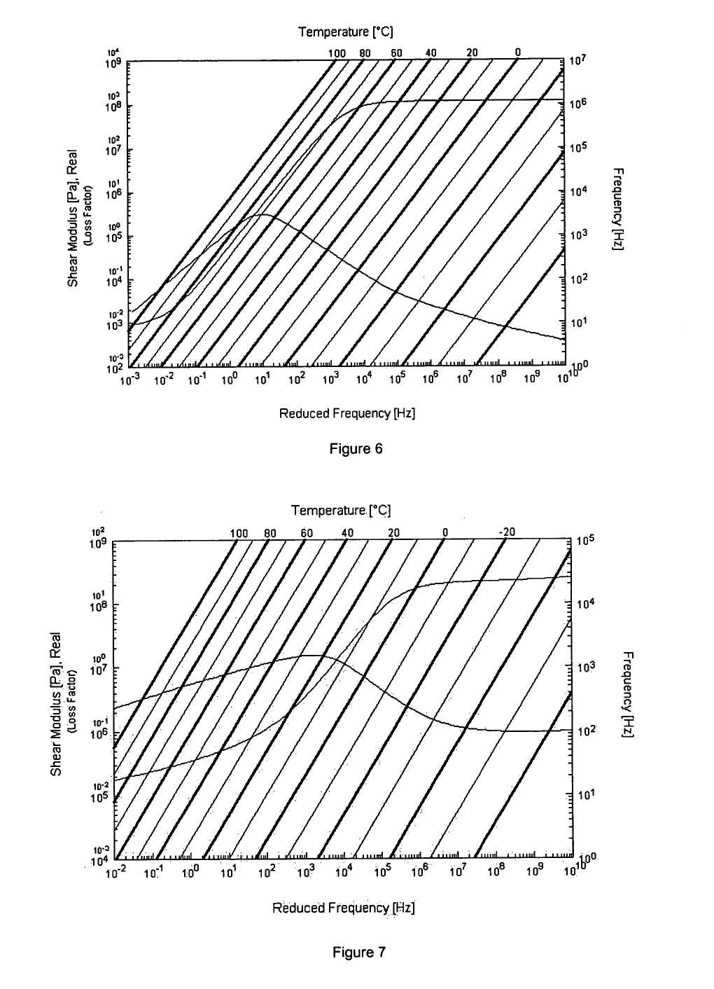

A nomogram of the material loss factor for the adhesive of Example 6 is shown in FIG. 6.

### Example 7

A sound dampening adhesive was prepared of the following ingredients:

| Ingredient | Weight (%) |
|---|---|
| Polytex 7000HS¹ | 89.85 |
| Viacryl SC108² | 10.13 |
| Aluminum³ | 0.02 |

¹Acrylic PSA produced by Avery Dennison Performance Polymers, Division of Avery Dennison Corp., Tg = −50.9° C.
²Thermoplastic acrylic resin from Surface Specialties, Tg = 57.6° C.
³Added as Aluminum acetyl acetonate crosslinker

A mixture of 119 kg Polytex 7000 HS, 23 kg toluene and 11.8 kg Viacryl CS 108/50T is prepared by adding the ingredients into a vessel and stirring for 20 minutes. A premix is prepared using 1.610 kg AAA, 0.268 kg 2,4 pentanedione and 4 kg parts toluene. This mixture is added to the acrylic copolymer/acrylic resin blend and stirred for an additional 15 minutes.

The resulting adhesive has a solids content of 40%, a Brookfield viscosity of 5000 mPa·s and a refractive index of 1.4435.

The adhesive of Example 7 is coated onto a presiliconized glassine paper at a wet coat weight of 200 gsm (73 g/m² on a dry weight basis) on a commercial coating line. The Loss Factor and Shear Modulus of the adhesive of Example 7 is measured by Vibrating Beam Technique (VBT) in accordance with ASTM-E-756-98. The Shear Modulus and Loss Factors as measured are plotted on the reduced frequency nomogram of FIG. 7 illustrating the damping properties of the adhesive.

### Example 8

A sound dampening adhesive is prepared substantially in accordance with the procedure of Example 3 with the following ingredients:

| Ingredient | Weight (%) |
|---|---|
| Polytex 7000HS¹ | 79.98 |
| PPO SA 120² | 19.99 |
| Aluminum³ | 0.025 |

¹Acrylic PSA produced by Avery Dennison Performance Polymers, Division of Avery Dennison Corp., Tg = −50.9° C.
²Polyphenylene ether from General Electric, Advanced Materials Tg = 152.2° C.
³Added as Aluminum acetyl acetonate crosslinker

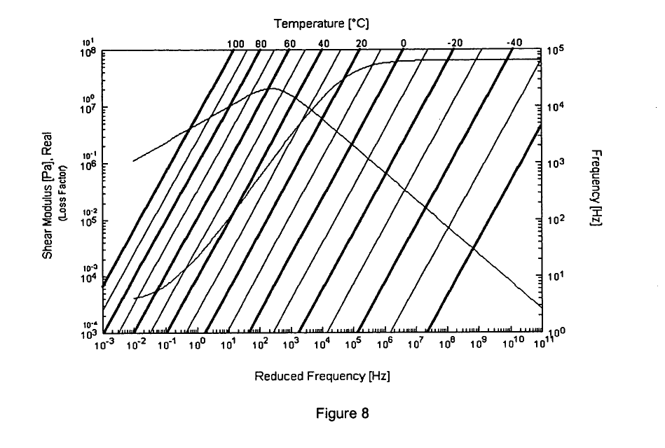

A nomogram of the material loss factor for the adhesive of Example 8 is shown in FIG. 8.

TABLE 1

| | 180° PASS¹ | 180° PAPE² | Dynamic shear |
|---|---|---|---|
| | 24 Hr | 24 Hr | 24 Hr. |
| Example | (N/25 mm) | (N/25 mm) | (N/625 mm²) |
| 1A | 18.9 | 0.9 | 514 |
| 1B | — | — | — |
| 2 | 33.3 | 13.7 | 22 |
| 3 | 3.7* | 0.1 | 704 |
| 4 | 3.4* | 0.1 | 645 |
| 5 | 1.3* | 0.2 | 763 |
| 6 | 4.5* | 0.1 | 649 |
| 7 | 14.2 | — | 440 |
| 8 | 13.5 | — | 630 |

¹PASS: peel adhesion on stainless steel
²PAPE: peel adhesion on polyethylene
*Adhesive Transfer: Poor anchorage on reinforcing polyester strip used in test, producing false “adhesive failure” indication at room temperature.

TABLE 2

| | 100 Hz | | 1 kHz | | 10 kHz | |
|---|---|---|---|---|---|---|
| | | Temp range | | Temp range | | Temp range |
| Exam- | peak | loss factor | peak | loss factor | peak | loss factor |
| ple | (° C.) | >0.8 (° C.) | (° C.) | >0.8 (° C.) | (° C.) | >0.8 (° C.) |
| 1A | 5 | −12 to 30 | 20 | 3 to 48 | 32 | 16 to 67 |
| 1B | −2 | −13 to 23 | 14 | 1 to 40 | 28 | 15 to 59 |
| 2 | 9 | −16 to 90 | 24 | −4 to 115 | 41 | 10 to 140 |
| 3 | 45 | 12 to >140 | 62 | 27 to >160 | 85 | 45 to >160 |
| 4 | 44 | 15 to 128 | 62 | 30 to >160 | 83 | 47 to >>160 |
| 6 | 40 | 17 to 67 | 59 | 33 to 88 | 81 | 51 to 114 |
| 7 | 7 | −10 to 44 | 21 | 3 to 63 | 38 | 17 to 84 |
| 8 | 17 | −2 to 47 | 34 | 13 to 66 | 52 | 28 to 88 |

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A damping pressure sensitive adhesive comprising a blend of:
40-95% by weight of an acrylic resin and 5-60% by weight of a thermoplastic modifying polymer having a Tg of at least 50° C.;
wherein the pressure sensitive adhesive has a material loss factor equal to or greater than about 0.8 at at least one frequency in the range of about 100 Hz to about 10 kHz and within a temperature span of at least 35° C. within the temperature region above 35° C.

2. The pressure sensitive adhesive of claim 1 comprising an amount of modifying polymer within the range of about 10 to about 40% by weight.

3. The pressure sensitive adhesive of claim 1 comprising an amount of modifying polymer within the range of about 20 to about 30% by weight.

4. The pressure sensitive adhesive of claim 1 wherein the modifying polymer comprises an acrylic resin.

5. The pressure sensitive adhesive of claim 1 wherein the modifying polymer comprises a polyphenylene ether.

6. The pressure sensitive adhesive of claim 1 wherein the modifying polymer comprises a rosin based resin.

7. The pressure sensitive adhesive of claim 1 wherein the modifying polymer comprises a terpene or terpene phenolic based resin.

8. The pressure sensitive adhesive of claim 1 wherein the modifying polymer comprises a polyester copolymer.

9. The pressure sensitive adhesive of claim 1 further comprising a crosslinking agent.

10. The pressure sensitive adhesive of claim 1 wherein the adhesive has a material loss factor equal to or greater than about 0.8 at at least one frequency in the range of about 100 Hz to about 10 kHz and within a temperature span of at least 35° C. within the temperature region above 40° C.

11. The pressure sensitive adhesive of claim 1 wherein the adhesive has a material loss factor equal to or greater than about 0.8 at at least one frequency in the range of about 100 Hz to about 10 kHz and within a temperature span of at least 35° C. within the temperature region above 70° C.

12. A pressure sensitive adhesive useful for damping purposes comprising a blend of:
60-95% by weight of a copolymer comprising on a copolymerized basis from about 55% to about 85% by weight of a monomer selected from the group consisting of alkyl acrylate esters and alkyl methacrylate esters containing from 4 to about 12 carbon atoms in the alkyl group and mixtures thereof, from 0 to about 35% by weight of an alkyl acrylate or methacrylate ester containing less than 4 carbon atoms in the alkyl group, from 0 to about 2% by weight of a glycidyl monomer, from about 0 to about 10% by weight of an N-vinyl lactam, and from 0 to about 15% by weight of an unsaturated carboxylic acid; and
5-40% by weight of a thermoplastic modifying polymer having a Tg of at least 50° C.

13. The pressure sensitive adhesive of claim 12 wherein the copolymer comprises on a copolymerized basis from about 55% to about 85% by weight of a monomer selected from the group consisting of alkyl acrylate esters and alkyl methacrylate esters containing from 4 to about 12 carbon atoms in the alkyl group and mixtures thereof, from 0 to about 35% by weight of an alkyl acrylate or methacrylate ester containing less than 4 carbon atoms in the alkyl group, from 0.01 to about 2% by weight of a glycidyl monomer, from about 1 to about 10% by weight of an N-vinyl lactam, and from 0 to about 15% by weight of an unsaturated carboxylic acid.

14. A damping adhesive construction comprising:
a damping adhesive comprising a blend of: 40-95% by weight of an acrylic adhesive; and 5-60% by weight of a thermoplastic modifying polymer having a Tg of at least 50° C.; wherein the pressure sensitive adhesive has a material loss factor equal to or greater than about 0.8 at at least one frequency in the range of about 100 Hz to about 10 kHz and within a temperature span of at least 35° C. within the temperature region above 35° C.; and
at least one substrate, wherein the adhesive is adhered to or laminated to the substrate.

15. The adhesive construction of claim 14 wherein the substrate comprises a release liner.

16. The adhesive construction of claim 14 wherein the substrate comprises a polymeric film.

17. The adhesive construction of claim 14 wherein the substrate comprises a metal.

18. The adhesive construction of claim 14 wherein the construction comprises a transfer tape.

19. A damping article comprising the adhesive of claim 1.
